(19) United States
(12) Patent Application Publication
(10) Pub. No.: US 2017/0211735 A1
(43) Pub. Date: Jul. 27, 2017

(54) GRIP AND FITTING ASSEMBLY

(71) Applicant: Tectran Mfg. Inc., Cheektowaga, NY (US)

(72) Inventors: James C. Papafagos, North Java, NY (US); Bruce D. McKie, Oakville (CA)

(73) Assignee: Tectran Mfg. Inc., Cheektowaga, NY (US)

(21) Appl. No.: 15/233,006

(22) Filed: Aug. 10, 2016

Related U.S. Application Data
(60) Provisional application No. 62/287,420, filed on Jan. 26, 2016.

(51) Int. Cl. F16L 33/22; F16L 21/08

(52) U.S. Cl. CPC F16L 33/22; F16L 21/08

(57) ABSTRACT

A grip and fitting assembly for coupling an air hose to a gladhand coupler. The grip being flexible and tapered with a tubular interior through which may pass a length of hose shielded and protected by the grip. The grip is affixed to a fitting attachable to the gladhand coupler on a first threaded end thereof and attachable to the air hose on a second barbed end thereof. The grip is configured with one or more internal keyway boss which aligns and interlocks with one or more corresponding keyway recess on a retaining shoulder formed between the ends of the fitting. The secure, snap-fit attachment between the grip and fitting ensures ease of operation, installation, maintenance, along with increased durability, weather-resistance, efficiency, usability, and reliability of the coupling.

### CROSS REFERENCE TO RELATED APPLICATIONS

This application claims benefit of priority of U.S. Provisional Patent Application Serial No. 62/287,420 filed Jan. 26, 2016, which is incorporated herein by reference.

### FIELD OF THE INVENTION

The invention described herein relates generally to the field of grip fitting assemblies for tube and hose connections. More specifically, the present invention provides improved operation, installation, durability, weather-resistance, and reliability of flexible grips, grip fittings and grip fitting assemblies for tube and hose line connections.

### BACKGROUND OF THE INVENTION

Applications of grips, fittings and grip fitting assemblies for tube and hose line connections within industrial and commercial environments require resistance to harsh environments and reliability under stress and strain forces during installation and operation. Such tube and hose lines may involve high pressure hydraulics or air and often require some flexibility of the tube or hose.

For example, air hose connections are commonly found in applications within the freight hauling industry. Such connections use a device known as a gladhand or gladhand coupler. This is an interlocking hose coupling fitted to hoses supplying pressurized air for air brake operation between a tractor cab unit and a freight trailer, or from a locomotive to railway air brakes on railroad cars. Gladhand couplers resemble a pair of “hands shaking” when interlocked and from where their name is derived. Gladhands are designed to allow the driver to manually disconnect hoses between tractor/trailer or between railcars without a mechanic or tools. They sometimes are quick release to speed up brake release time. Often, gladhands are color coded with service lines being blue and emergency brake lines being red. Mated rubber grommets provide a positive seal, and the joined halves may separate during operation if certain pull stresses are present at the hose or tube connection. Gladhand couplers are typically standardized in size and mating geometry which allows them to be connected to each other, for example allowing either end of a railcar to be connected to the end of a train or for one trucking company's tractor cabs to connect to any number of freight trailers.

Inherent to the freight industry is the constant coupling and decoupling of gladhand connections as trailers are left for loading or unloading and other trailers are picked up for delivery. Gladhands are of course affixed to a length of air hose or tube. The manual act of coupling and decoupling gladhands places stress and strain upon the connected hose. This is exacerbated by the fact that gladhands are prone to corrosion making their mating surfaces more difficult to couple and uncouple over time. During installation and operation of an air brake hose in the freight hauling context, the flexible hose undergoes stress from bending, twisting, and kinking, particularly at the fitting ends of the air brake lines. For instance, tractor-trailer operators subject air brake lines to twisting while bending them into position in tight quarters between tractor and trailer. Drivers and fleet maintenance personnel repetitively connect and disconnect air brake lines between the tractor and trailer using hand holds on the hose at the fittings to achieve the needed leverage to secure and release gladhand connections.

Conventional grips, fittings and grip fitting assemblies, however, do not offer sufficient protection against kinking of the hose and tube at the gladhand connections. Conventional hose and tube assemblies using only coiled springs at the fittings are subject to corrosion, and provide inadequate protection from the shearing action that takes place during gladhand connection where the spring coils shift and do not prevent kinking and bending during installation and operation. Some rigid grip aids to the gladhand connection process create a more severe angle during tight radius turns putting further stress on air brake lines at the gladhands, reducing the life of air brake hoses and risking failure under operation of the tractor-trailer air brake system. When not in use (e.g., tractor cab not connected to a tractor trailer), air hoses are often stored in a manner such that the weight of the dangling gladhand stresses the hose to which the gladhand is connected. Further, gladhand connections to the hose, which often include grips, fittings and grip fitting assemblies, undergo continuous exposure to the elements while in use, often in frigid conditions. Winter road salts and brine, dirt, grease, and other solvents erode fittings and assemblies of critical air brake connections. For tractor-trailer connections, protection of fittings that join the air hose and gladhand from the elements with weather resistant, low-temperature materials and coatings is essential to the safety of the driver and public highway motorists.

What is needed is a coupling mechanism that overcomes these and other disadvantages of conventional fittings and fitting assemblies.

### BRIEF SUMMARY OF THE INVENTION

One skilled in the art will appreciate that the present teachings can be practiced with embodiments other than those summarized or disclosed below by the Figures and Detailed Description of the Invention to follow.

In general, the present invention includes a tapered flexible grip and interlocking fitting which combined form a grip fitting assembly. The assembly is used to connect a coupling mechanism such as, but not limited to, a gladhand to a length of hose or tubing. It should be understood that hose and tubing, while sometimes used synonymously, have one major difference. Hoses are generally reinforced in some way. Typical reinforcements are imbedded braid reinforcement, wire reinforcement, reinforcement with a stiffer plastic or other material, dual walls or a very heavy wall. Hose is typically used and rated for applications that involve high pressure. Tubing is not reinforced or is sparsely reinforced and is often used for gravity flow or lower pressure applications.

For purposes of the following discussion, the term “hose” will be used though should not be considered as limiting the invention. Likewise, the exemplary embodiment of the inventive assembly being used within a gladhand coupling tractor and trailer air hoses should be understood as but one example of an implementation of the present invention. Indeed, the present invention may be implemented within a variety of tube and hose line connections for many industrial and commercial applications.

The present invention includes a grip and fitting assembly including: a flexible tapered grip having a substantially tubular interior, a first end of which includes an interior seating surface, an annular lip perpendicular to the interior seating surface, and at least one keyway boss located within a sidewall of the substantially tubular interior along the annular lip and adjacent to the interior seating surface; a fitting having a first coupling end, a second coupling end, a retaining shoulder located between the first coupling end and the second coupling end, and an exterior seating surface located between the retaining shoulder and the first coupling end, the retaining shoulder including at least one keyway recess suitably dimensioned to matingly correspond to the at least one keyway boss; wherein the at least one keyway boss and the at least one keyway recess are configured to interlock upon abutment of the interior seating surface with the exterior seating surface so as to preclude rotational movement between the grip and the fitting.

The present invention also includes a grip and fitting assembly for coupling an air hose to a gladhand coupler, the assembly including: a flexible tapered grip having a substantially tubular interior, a first end of which includes an interior seating surface, an annular lip perpendicular to the interior seating surface, and three keyway bosses located within a sidewall of the substantially tubular interior, the keyway bosses spaced equidistantly along the annular lip and adjacent to the interior seating surface; a fitting having a first coupling end threaded to accept a gladhand coupler, a second coupling end barbed to accept and retain a length of air hose thereon, a retaining shoulder located between the first coupling end and the second coupling end, and an exterior seating surface located between the retaining shoulder and the first coupling end, the retaining shoulder including three keyway recesses each suitably dimensioned to matingly correspond to a related one of the keyway bosses; wherein the keyway bosses and the keyway recesses are configured to interlock upon abutment of the interior seating surface with the exterior seating surface so as to preclude rotational movement between the grip and the fitting.

The above and other benefits and advantages of the present invention will be readily apparent from the Brief Description of the Drawings and the Invention and Detailed Description to follow.

### BRIEF DESCRIPTION OF THE DRAWINGS

Embodiments of the present invention will now be described, by way of example only, with reference to the attached Figures, wherein:

FIG. 1 shows a perspective view of flexible tapered grip assembly according to the present invention shown with grip and fitting sections disconnected.

FIG. 2 shows a side view of a complete flexible tapered grip assembly of the invention connected with related elements shown in silhouette.

FIG. 3 shows an end view of the grip section of the invention, the end view being from the right end of FIG. 4.

FIG. 4 shows a side section view of the grip section of the invention taken along line 4-4 of FIG. 3.

FIGS. 5A through 5C show a series of close-up side views with the fitting section shown intact and a partial length of the grip section shown in a cutaway lengthwise cross section so as to illustrate the before, during, and after stages of fitting insertion into the grip.

FIG. 6 shows a side view of the complete flexible tapered grip assembly of the invention connected with related elements shown in silhouette taken along line 6-6 of FIG. 3.

FIG. 7 shows a close-up view of the flexible tapered grip assembly according to the present invention shown with grip and fitting sections disconnected and the grip section partially cutaway to reveal internal keyway boss structures.

### DETAILED DESCRIPTION

The present invention will now be described more fully herein with reference to exemplary embodiments, examples of which are illustrated in the accompanying drawings. Embodiments and implementations set forth in the following detailed description do not represent all embodiments and implementations of the claimed invention.

More specifically, the present invention provides improved operation, installation, durability, weather-resistance, and reliability of flexible grips, grip fittings and grip fitting assemblies for nylon tube and rubber hose line connections in trucking tractor-trailer air brake systems. It should, however, be readily apparent that although such specific implementation within trucking tractor-trailer air brake systems is discussed in accordance with a preferred embodiment, there may be other equally suitable implementations of the present invention outside such context of trucking and which are well within the intended scope of the present disclosure. In particular, the present invention may be applicable to any suitable mobile or fixed implementation including, but not limited to, hydraulic connections, fuel or other fluid transfer, land or marine connections, airplane terminal vestibules, ship-to-shore connections, and may be dry or wet lines.

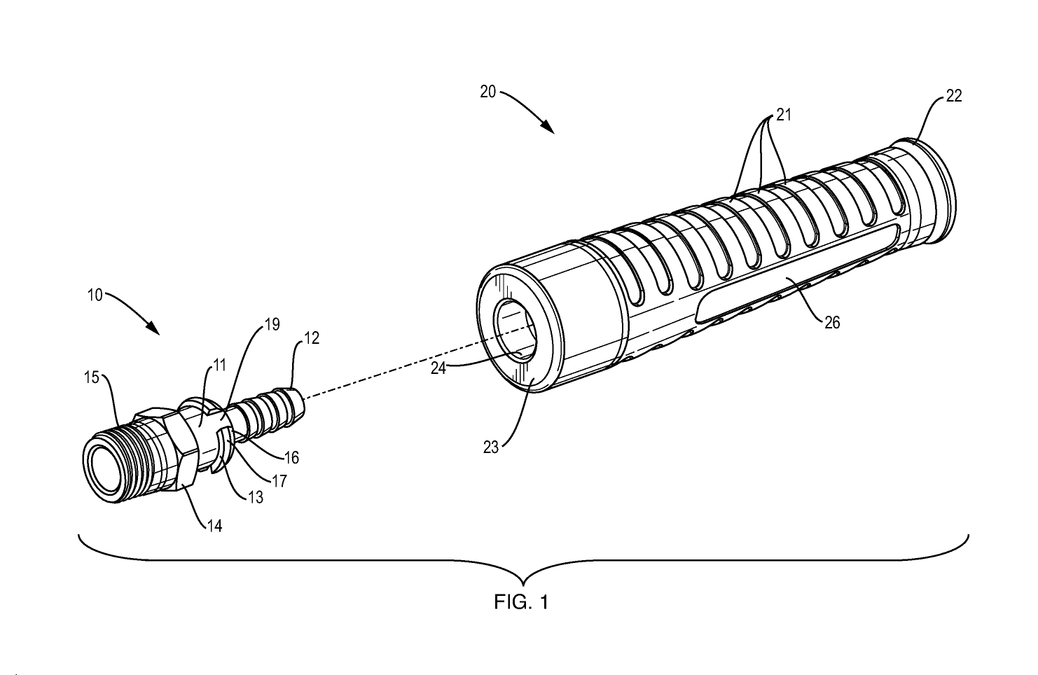

With regard to FIG. 1, there is seen a three-dimensional illustration showing a flexible tapered grip assembly in accordance with the present invention shown with two sections, one being a fitting 10 and the other being a grip 20. For purposes of illustration, the assembly is shown where the fitting 10 and grip 20 are in a disconnected position relative to one another.

The grip 20 is a both flexible and tapered. Flexibility of the grip provides the ability of the grip to bend and yet return to its original shape. The grip 20 itself is a unitary structure fabricated from material suitable for the intended trucking environment which may be hostile to materials—i.e., where wide temperature variations occur and exposure to road salt and a variety of chemicals may occur. One suitable material includes thermoplastic vulcanizates (TPV) which are part of the thermoplastic elastomer (TPE) family of polymers. TPVs offer a combination of elastomeric properties, like compression and tension set, coupled with aging performance and chemical resistance. Other materials such as, but not limited to, ethylene propylene diene monomer (EPDM) thermoset rubber, nylon, or polyvinyl chloride (PVC) may be possible depending upon the intended environment. For example, PVC may not be suitably used for an intended cold weather implementation where flexibility is severely limited at reduced environmental temperatures. The grip 20 may be formed in any suitable manner including, but not limited to, injection molding. It should also be understood that the grip may be colored during molding and provided in a variety of color schemes (i.e., color coded) in accordance with any desired implementation (e.g. red for emergency brake lines, blue for service lines) and which assists to minimize incorrect tractor/trailer connections

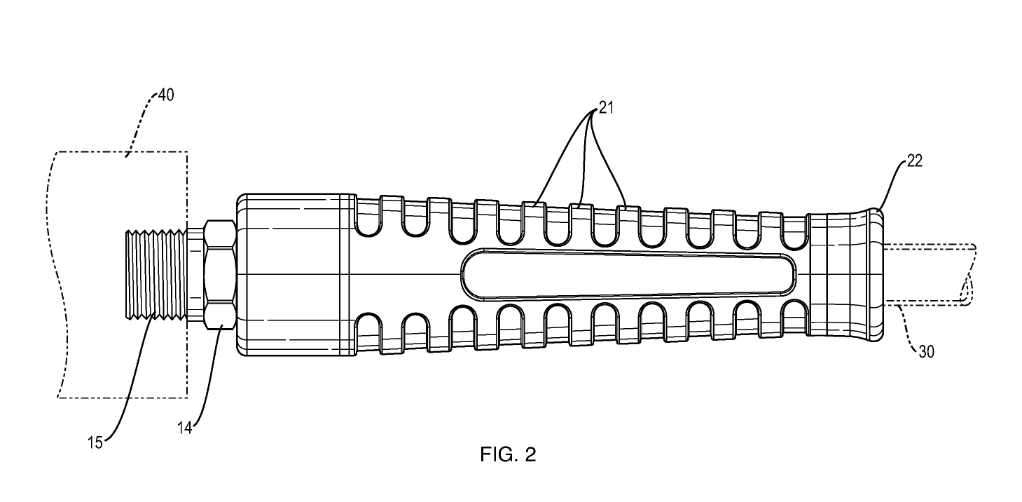

With continued reference to FIG. 1 and additional reference to FIG. 2, the grip 20 is seen as tapered from end to end. In particular, the grip 20 has an increased thickness at a first end 23 tapering to an opposite, second end that includes a tear-resistant rail 22. The rail 22 is thickened so as to form a suitably reinforced ring around a length of air hose (shown by dotted line 30). Oftentimes, such portion of air hose also includes a spring guard (not shown) to assist and support the flexing of the hose. Providing the thickened rail 22 at the spring guard end of the grip 20 prevents tearing of the grip 20 and improves kink resistance of hose and tube made of weather resistant, low-temperature materials and coatings.

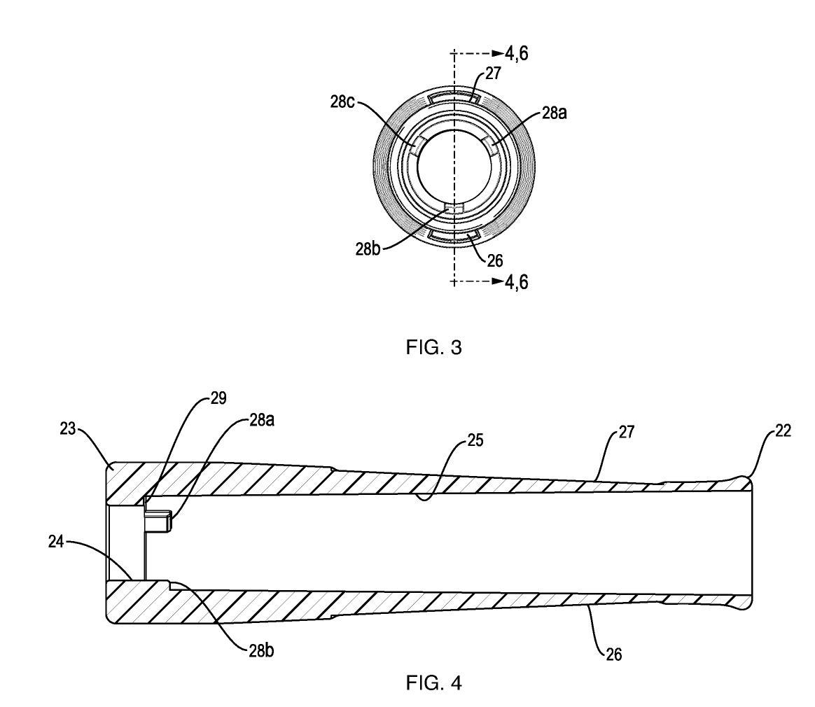

The grip 20 includes traction ridges 21 for an additional non-slip feature when the grip 20 is handled by a user. Recessed areas 26 (and 27 visible in FIGS. 3 and 4) may be provided for corporate labeling or cosmetic logos.

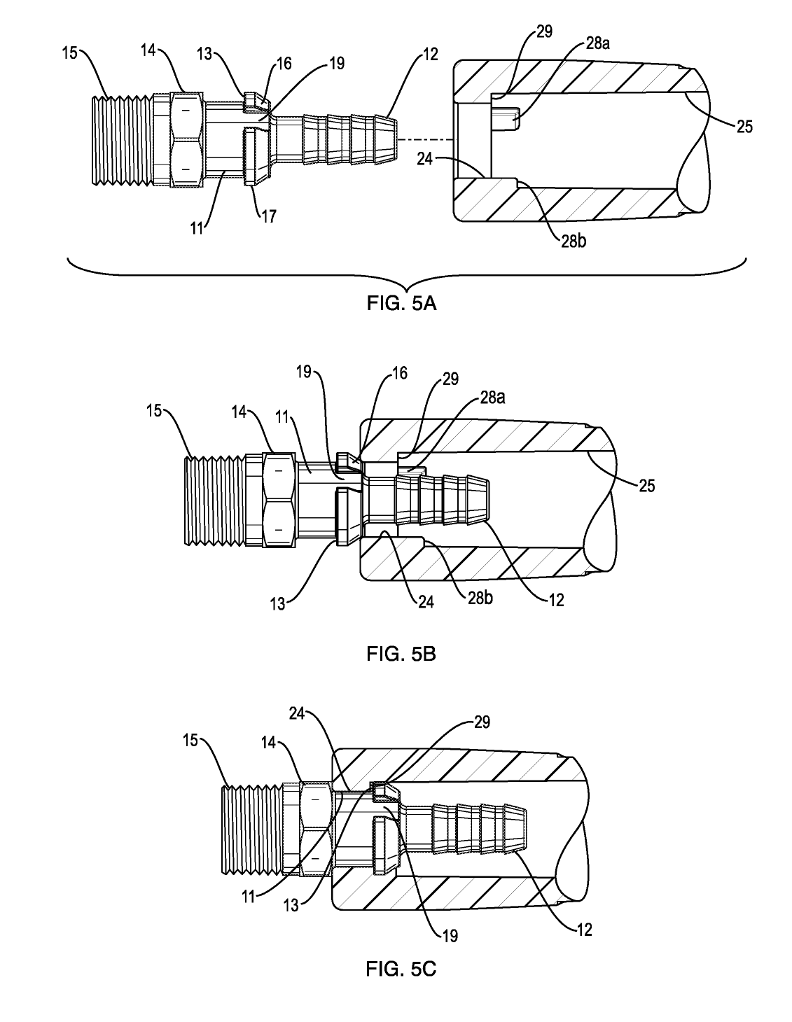

A fitting 10 is also shown in accordance with the inventive assembly. The fitting 10 includes a first coupling end 15 and a second coupling end 12 between which is located an exterior seating surface 11. It is the exterior seating surface 11 of the fitting 10 and the interior seating surface 24 of the grip 20 which are intended to abut upon insertion of the fitting 10 into the first end 23 of the grip 20. Such insertion is shown and described further below with regard to FIGS. 5A through 5C.

With continued reference to FIGS. 1 and 2, the fitting 10 is seen to include a retaining shoulder 17 located between the first coupling end 12 and the second coupling end 15. The retaining shoulder 17 has two sides with two very distinct purposes. One side of the retaining shoulder 17 includes a ramped surface 16. The ramped surface 16 is intended as the part of the fitting 10 which first contacts the first end 23 of the grip 20 upon insertion of the fitting 10 into the grip 20. The interior seating surface 11 may also include a beveled edge which facilitates the ramped surface 16 to at least initially contact the interior seating surface 11. The other side of the retaining shoulder 17 includes a shoulder surface 13. The shoulder surface 13 is opposite the ramped surface 16 and is oriented perpendicular to the exterior seating surface 11.

The fitting 10 itself is formed from a corrosion-resistant material such as, but not limited to brass. The first end 15 of the fitting is provided with threading and a hex-nut section 14 of the fitting 10 is provided to enable a user to utilize a wrench to connect the fitting 10 to a coupling mechanism (shown in dotted line as 40). The coupling mechanism 40 may be any suitable universal coupling mechanism such as, but not limited to, the aforementioned gladhand or similar coupler. As should be readily apparent from the description thus far and the accompanying FIG. 2, the inventive grip and fitting assembly provides a new and useful means of connecting a universal coupling 40 to a length of hose 30.

With reference to FIGS. 3 and 4, there are respectively shown an end view and a side cross section view of the grip 20. In particular, FIG. 3 shows an end view of the grip section of the invention, the end view being from the right end of FIG. 4 while FIG. 4 shows a side section view of the grip section of the invention taken along line 4-4 of FIG. 3. Here, the grip 20 is seen to include three keyway bosses 28a, 28b, 28c with only two 28a, 28b visible in cross section FIG. 4.

It should be understood that each keyway boss 28a, 28b, 28c corresponds to a keyway recess 19 located on the fitting 10. As seen in FIG. 1, the retaining shoulder 17 includes such keyway recesses and which are suitably dimensioned to matingly correspond a related keyway boss though only one of three such keyway recesses are visible. From FIG. 4, it can be seen that each keyway boss (28a and 28b visible) are located within a sidewall 25 of the substantially tubular interior 25 of the grip 20. More specifically, each keyway boss is arranged along an annular lip 29 and adjacent to the interior seating surface 24. It should be noted that while three keyway bosses and three corresponding keyway recesses are discussed, there may be any number of suitable pairs of keyway bosses and recesses such as, but not limited to, one, two, or four.

The annular lip 29 is configured perpendicular to the interior seating surface 24 and provides a surface against which the shoulder surface 13 of the fitting's shoulder 17 firmly abuts once the fitting 10 is completely inserted within the first end 23 of the grip 20.

With regard to FIGS. 5A through 5C, there are illustrated a series of close-up side views showing the fitting along with a partial length of the grip. The partial length of the grip is illustrated as a cutaway lengthwise cross section so as to show a chronological series of before, during, and after stages of fitting insertion into the grip.

As shown in FIG. 5B, the ramped surface 16 of the fitting first meets the outer edge of the interior seating surface 24. Such outer edge of the interior seating surface 24 may be beveled to facilitate movement of retaining shoulder 17 through and over the entirety of the interior seating surface 24. Here, it is also visible that the retaining shoulder 17 is sized with an outer dimension slightly larger than the inner dimension of the interior seating surface 24.

It should be understood that the material from which the grip is fabricated will have elastic qualities such that the interior seating surface 24 will expand to allow the retaining should 17 to ride over it, but snap back into place once the retaining shoulder 17 is completely through and past the interior retaining surface 24. This snap-fit action results in the configuration seen in FIG. 5C. Here, the interior seating surface 24 is shown abutting the exterior seating surface 11 of the fitting. Likewise, the annular lip 29 of the grip is shown abutting the shoulder surface 13 which effectively permanently retains the fitting within the grip. Moreover, in such configuration shown, each keyway boss 28a-28c and each corresponding keyway recess 19 interlock with one another upon abutment of the interior seating surface 24 with the exterior seating surface 11 so as to preclude rotational movement between the grip and the fitting. In this manner, both rotational and axial movement of the fitting within grip is prevented as the two are locked into place.

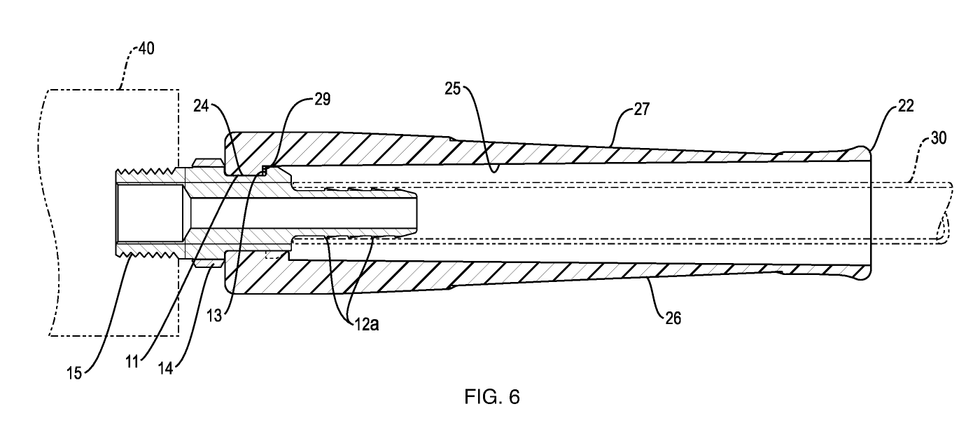

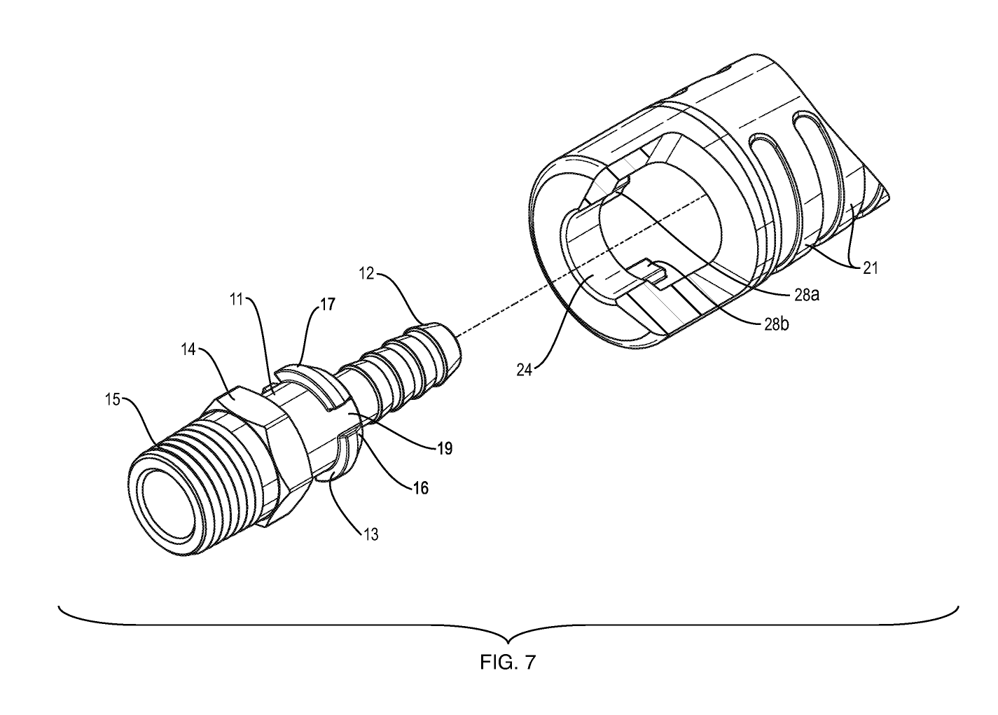

FIG. 6 illustrates a side view of the complete flexible tapered grip assembly taken along line 6-6 of FIG. 3. Here, the invention is shown after the fitting is snap-fit into the grip and after the fitting is threaded to a coupling mechanism 40 and length of tubing 30. In particular, it should be noted that the fitting includes barbs 12a, or some suitable structure, which retain the length of tubing 30 upon the fitting. The tubular interior 25 of the grip itself is also suitably larger than the outer diameter of the tubing 30 so as to allow both unrestricted movement of the tube and yet still allow the grip to function as a strain relief boot with integrated fitting for hydraulic connections. Thus, the present invention is a dual purpose strain relief boot and a grip for manual manipulation of a coupler (e.g., gladhand). Likewise, the space provided between the tubular interior 25 and the outer diameter of the tubing 30 also enables a coil spring (not shown) to be inserted over the tubing 30 all the way up to the fitting, further enhancing flexibility of the inventive assembly.

The strain relief aspect of the present invention also provides an “anti-kinking” characteristic such that the tubing attached to the fitting through the tapered grip section is precluded from kinking. Unrestricted movement of the tube within the grip at the end opposite the fitting occurs only to a point at which bending of the given tube will result in the tube coming into contact with the sidewall of the grip. Due to the tapered nature of the grip, the ability of the grip to bend along with the tube is a function of the thickness of the grip. The thinner end will therefore bend along with the abutting tube in a manner that is proportional with the varied thickness of the grip wall. This tapering provides flexible support of the tube while inhibiting the ability of the tube to kink. This is effective against kinking that may otherwise (in the absence of the present invention) occur during the time of connection or at the time of operation (e.g., during a turning of the tractor cab relative to the trailer). Elongation of the grip may be provided so as to further enhance the anti-kinking characteristics of the present invention. In such elongation instance, the grip may be provided in successively tapering sections interconnected to one another.

It should therefore be understood that the sidewall of the flexible tapered grip decreases in thickness along the substantially tubular interior from fitting end to a tear-resistant rail end, so as to oppose kinking of the tube during installation and operation. Moreover, the tear-resistant rail engages with the tube upon minimal bending radius, so as to provide freedom of movement of the tube during initial bending. Thus, the opposing of kinking of the tube is an increasing function of the decrease in thickness from fitting end to rail end and elongation of the flexible tapered grip. In this manner, the grip is elongated along the tube so as to increase anti-kinking characteristics of the overall grip and fitting assembly relative to the tube.

FIG. 7 is provided so as to more clearly illustrate the details of the internal keyway boss structures. Here, a close-up view of the flexible tapered grip assembly according to the present invention shows the grip and fitting sections disconnected and the grip section partially cutaway to reveal the internal keyway bosses 28a, 28b. Though three exist, it should be readily apparent that due to the cutaway aspect of FIG. 7 only two are shown. From this figure, it should be readily apparent that each keyway boss is formed integrally with the grip as part of the sidewall of the tubular interior 25. Moreover, the keyway boss has a surface that is collinear with the interior seating surface 24. Thus, the keyway boss structures are internal and integral with the unitarily formed grip.

In terms of implementation and use of the present invention, when used in conjunction with the all brass, corrosion-resistance fittings of the present invention, the grip and fitting assembly of the present invention provides improved bend and kink resistance during installation, operation, and gladhand connections and disconnections. Specifically, the present invention provides an improved thermo-composite flexible tapered grip and fitting design, the grip having increased thickness at the fitting end tapering to a tear-resistant rail at the hose and tube end of the fitting. The flexible tapered grip and grip fitting of the present invention further simplifies manufacture of the grip fitting assembly reducing cost and providing for longer operational life under bending and kinking.

While the foregoing description of the invention enables one of ordinary skill to make and use what is considered presently to be the best mode thereof, those of ordinary skill will understand and appreciate the existence of variations, combinations, and equivalents of the specific embodiments and examples herein. The above-described embodiments of the present invention are intended to be examples only. Alterations, modifications and variations may be effected to the particular embodiments by those of skill in the art without departing from the scope of the invention, which is defined solely by the claims appended hereto.

The invention is therefore not limited by the above-described embodiments and examples, or embodiments and applications within the scope and spirit of the invention claimed as follows.

1. A grip and fitting assembly comprising:
a flexible tapered grip (20) having
a substantially tubular interior (25), a first end (23) of which includes an interior seating surface (24),
an annular lip (29) perpendicular to said interior seating surface (24), and
at least one keyway boss (28a) located within a sidewall of said substantially tubular interior (25) along said annular lip (29) and adjacent to said interior seating surface (24);
a fitting (10) having a first coupling end (15), a second coupling end (12), a retaining shoulder (17) located between said first coupling end (12) and said second coupling end (15), and an exterior seating surface (11) located between said retaining shoulder (17) and said first coupling end (15), said retaining shoulder (17) including at least one keyway recess (19) suitably dimensioned to matingly correspond to said at least one keyway boss (28a);
wherein said at least one keyway boss (28a) and said at least one keyway recess (19) are configured to interlock upon abutment of said interior seating surface (24) with said exterior seating surface (11) so as to preclude rotational movement between said grip (20) and said fitting (10).

2. The assembly as claimed in claim 1, wherein said retaining shoulder (17) has an outermost diameter greater than an innermost diameter of said interior seating surface (24).

3. The assembly as claimed in claim 2, wherein said retaining shoulder (17) includes a ramped surface (16) adjacent said second coupling (12) facilitating movement of said retaining shoulder (17) across said interior seating surface (24).

4. The assembly as claimed in claim 3, wherein said retaining shoulder (17) includes a shoulder surface (13) opposite said ramped surface (16) and perpendicular to said exterior seating surface (11).

5. The assembly as claimed in claim 4, wherein said retaining shoulder (17) includes a shoulder surface (13) opposite said ramped surface (16) and perpendicular to said exterior seating surface (11).

6. The assembly as claimed in claim 5, wherein said shoulder surface (17) and said annular lip (29) are configured to snap fit against one another upon abutment of said interior seating surface (24) with said exterior seating surface (11) so as to preclude axial movement between said grip (20) and said fitting (10).

6. The assembly as claimed in claim 6, wherein said first coupling (15) is threaded to accept a universal coupling mechanism (40).

8. The assembly as claimed in claim 7, wherein said universal coupling mechanism (40) is a gladhand.

9. The assembly as claimed in claim 6, wherein said second coupling (12) is barbed to accept a flexible conduit (30).

10. The assembly as claimed in claim 9, wherein said flexible conduit (30) is a length of air hose.

11. The assembly as claimed in claim 6 including more than one said keyway boss (28a) and, correspondingly, more than one said keyway recess (19).

12. The assembly as claimed in claim 6 including a rail (22) located at a second end of said grip (20) opposite said first end (23), said rail being thickened.

13. A grip and fitting assembly for coupling an air hose to a gladhand coupler, said assembly comprising:
a flexible tapered grip having
a substantially tubular interior, a first end of which includes an interior seating surface,
an annular lip perpendicular to said interior seating surface, and
three keyway bosses located within a sidewall of said substantially tubular interior, said keyway bosses spaced equidistantly along said annular lip and adjacent to said interior seating surface;
a fitting having a first coupling end threaded to accept a gladhand coupler, a second coupling end barbed to accept and retain a length of air hose thereon, a retaining shoulder located between said first coupling end and said second coupling end, and an exterior seating surface located between said retaining shoulder and said first coupling end, said retaining shoulder including three keyway recesses each suitably dimensioned to matingly correspond to a related one of said keyway bosses;
wherein said keyway bosses and said keyway recesses are configured to interlock upon abutment of said interior seating surface with said exterior seating surface so as to preclude rotational movement between said grip and said fitting.

14. The assembly as claimed in claim 13, wherein said retaining shoulder has an outermost diameter greater than an innermost diameter of said interior surface.

15. The assembly as claimed in claim 14, wherein said retaining shoulder includes a ramped surface adjacent said second coupling facilitating movement of said retaining shoulder across said interior surface.

16. The assembly as claimed in claim 15, wherein said retaining shoulder includes a shoulder surface opposite said ramped surface and perpendicular to said exterior seating surface.

17. The assembly as claimed in claim 15, wherein said shoulder surface and said annular lip are configured to snap fit against one another upon abutment of said interior seating surface with said exterior seating surface so as to preclude axial movement between said grip and said fitting.

18. A grip and fitting assembly for use in conjunction with a tube, said assembly comprising:
a flexible tapered grip (20) having
a substantially tubular interior (25), a first end (23) of which includes an interior seating surface (24),
an annular lip (29) perpendicular to said interior seating surface (24), and
at least one keyway boss (28a) located within a sidewall of said substantially tubular interior (25) along said annular lip (29) and adjacent to said interior seating surface (24);
a fitting (10) having a first coupling end (15), a second coupling end (12), a retaining shoulder (17) located between said first coupling end (12) and said second coupling end (15), and an exterior seating surface (11) located between said retaining shoulder (17) and said first coupling end (15), said retaining shoulder (17) including at least one keyway recess (19) suitably dimensioned to matingly correspond to said at least one keyway boss (28a);
said fitting connectable to a tube placed through said grip, said grip capable of acting upon said tube in a manner so as to preclude kinking of said tube; and
wherein said at least one keyway boss (28a) and said at least one keyway recess (19) are configured to interlock upon abutment of said interior seating surface (24) with said exterior seating surface (11) so as to preclude rotational movement between said grip (20) and said fitting (10).

19. The assembly as claimed in claim 18, wherein said grip is elongated along said tube so as to increase anti-kinking characteristics of said assembly relative to said tube.

20. The assembly as claimed in claim 19, wherein said grip is provided in successively tapering interconnected sections.
